(19) United States
(12) Patent Application Publication
(10) Pub. No.: US 2016/0207605 A1
(43) Pub. Date: Jul. 21, 2016

(54) HIGH ALTITUDE BALLOON APEX ASSEMBLY

(71) Applicants: Brad Jensen, Beresford, SD (US); Josh McQuade, Sioux Falls, SD (US); Derek Jensen, Tea, SD (US); Eric Jon Baack, Crooks, SD (US)

(72) Inventors: Brad Jensen, Beresford, SD (US); Josh McQuade, Sioux Falls, SD (US); Derek Jensen, Tea, SD (US); Eric Jon Baack, Crooks, SD (US)

(21) Appl. No.: 14/995,629

(22) Filed: Jan. 14, 2016

Related U.S. Application Data
(60) Provisional application No. 62/103,790, filed on Jan. 15, 2015.

(51) Int. Cl. B64B 1/58; B64B 1/40

(52) U.S. Cl. CPC B64B 1/58; B64B 1/40

(57) ABSTRACT

An atmospheric balloon comprises a membrane surrounding a chamber and extending between an upper and lower apex. An apex plate coupled to the membrane comprises a plate body including a termination opening with a portion of the membrane spread across the termination opening and a cutting device coupled to the plate body to cut the membrane to forma flight-termination opening. A fill port assembly is coupled to the plate body and in communication with the chamber. An adhesive assembly comprises one or more bridging panels that span between a first coupling interface coupled to the apex plate and a second coupling interface coupled to the membrane, and adhesive between the membrane and the apex plate, between the one or more bridging panels and the apex plate at the first coupling interface, and between the one or more bridging panels and the membrane at the second coupling interface.

### CROSS-REFERENCE TO RELATED APPLICATION

This application claims priority to U.S. Provisional Patent Application 62/103,790, filed on Jan. 15, 2015, which application is incorporated by reference herein in its entirety.

### BACKGROUND

This document pertains generally, but not by way of limitation, to balloons and inflatable bladders having atmospheric application. Lobed balloons can be used in high-altitude ballooning. A lobed balloon can have a shape with a relatively high curvature that can allow for larger diameter balloons using relatively thin material for the balloon material. In at least some examples, payloads including instruments, communications equipment and the like are coupled with or suspended from the lobed balloon. The payloads can be configured to conduct operations (e.g., observation, communication and the like) at the high altitudes lobed balloons reach, for instance an altitude of 20 miles.

Examples of lobed balloons can be constructed with a lightweight material that is provided in diamond shaped panels of material, e.g., a gore pattern, that extend from top apex to a bottom apex and taper from near a midpoint toward the top and bottom apexes. The diamond shaped panels can be bonded to one another along their respective longitudinal edges to form the balloon. The balloon accordingly can have a plurality of longitudinal seams extending from the top to the bottom of the balloon, with one seam between adjacent diamond shaped panels. The wider midpoint of each of the diamond shaped panels can provide the outwardly curving shape of the balloon with respect to the narrower top and bottom apexes. Optionally, a balloon can be constructed with an upper and a lower panel coupled together along an edge.

In other examples, a balloon can include a nested inner balloon, also referred to as a ballonet, which can be provided within a larger balloon (e.g., a balloon within a balloon). The ballonet can be coupled at an end of the larger balloon, for instance the bottom end of the larger balloon, and can have a roughly spherical shape that fills at least a portion of the larger balloon. The ballonet (inner balloon) can be inflated and deflated within the larger balloon. Inflation and deflation of the ballonet with atmospheric air can provide ballast to the larger balloon by minimizing the remaining volume of the larger balloon dedicated to a lighter-than-air lifting gas, such as helium, that provides buoyancy.

### BRIEF DESCRIPTION OF THE FIGURES

In the figures, which are not necessarily shown to scale, like numerals or names may describe similar components in different views. The figures illustrate generally, by way of example, but not by way of limitation, various embodiments discussed in the present document.

FIG. 1 is a side view of an example atmospheric balloon system for high-altitude flight.

FIG. 2 is a top view of an example apex plate for use on an atmospheric balloon system.

FIG. 3 is a cross-sectional side view of an example fill port assembly installed in an apex plate for use on an atmospheric balloon system.

FIG. 4 is an exploded perspective view of the example fill port assembly of FIG. 3.

FIG. 5 is a perspective view of the example apex plate of FIG. 2, showing details of an example flight-termination system for use on an atmospheric balloon system.

FIG. 6 is an exploded perspective view of an example cutting mechanism for use with the example flight-termination system of FIG. 5.

FIG. 7 is a close-up perspective view of the flight-termination system of FIG. 5.

FIG. 8 is a top view of an example adhesive assembly for coupling an apex plate o a balloon membrane with an adhesive and without fasteners.

FIG. 9 is a cross-sectional side view of the example adhesion assembly taken along line 9-9 in FIG. 8.

FIG. 10 is a flow diagram of an example method of adhering an apex plate to a balloon membrane with an adhesive and without the use of other fasteners.

### DETAILED DESCRIPTION

The following Detailed Description describes an improvement of balloons that are designed for stratospheric flight. The balloons can include an apex structure configured to address the following:
a. Easier control of inflation of the balloon
b. Securing of the upper apex structure with fewer holes through the balloon membrane, resulting in less potential for leaking of the lifting gas and more optimized lifting gas retention.
c. Flight-termination with a cutting mechanism that requires no breaching of the membrane before flight termination and that can provide for flight termination with a stored-energy mechanism that can be triggered with minimal energy.

The balloon can be “pumpkin balloon style” (or other configuration or shape) that can be used for long duration stratospheric flight of payloads and provides for limited steering capability along the flight path occurring as a result of varying wind directions at flight altitudes.

### Dual Chamber Balloon

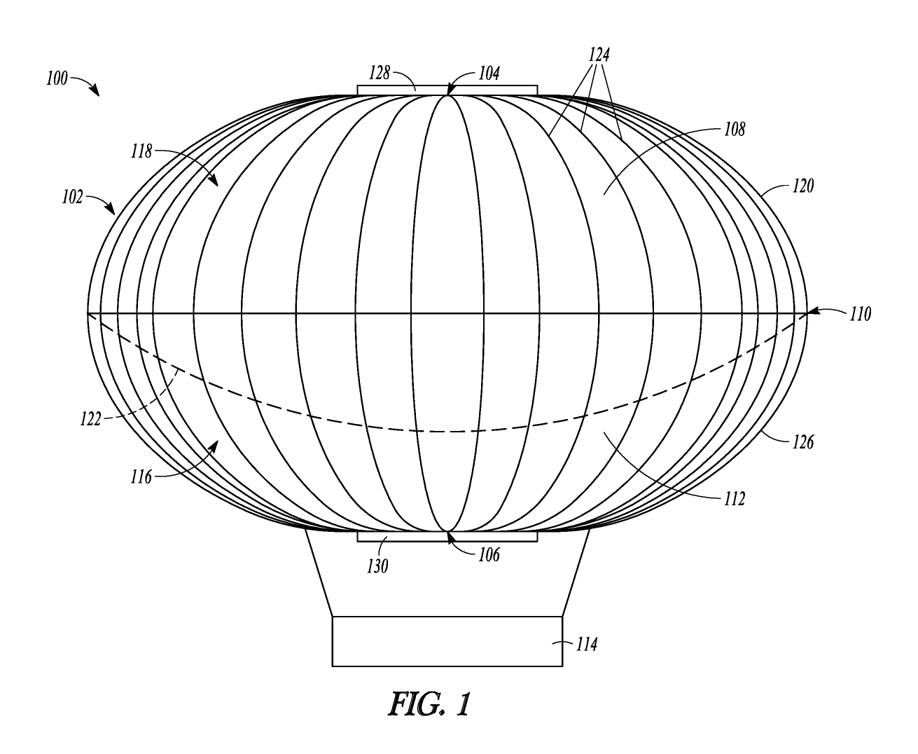

FIG. 1 shows an example of an atmospheric balloon system 100. The atmospheric balloon system 100 can include a balloon 102. In an example, the balloon 102 can be one or more of a dual-chamber balloon, a pumpkin balloon, or a lobed balloon. The balloon 102 can be formed between an upper apex 104 and a lower apex 106. An upper balloon panel 108 can extend from the upper apex 104 to a circumferential edge 110. A lower balloon panel 112 can extend from the lower apex 106 to the circumferential edge 110. The upper balloon panel 108 and the lower balloon panel 112 can be provided as discs or portions of discs and can be sealed along the circumferential edge 110. As used herein, the term “high-altitude,” when referring to flight of the balloon system 100, can mean an altitude of from about 30,000 feet to about 130,000 feet, such as from about 50,000 feet to about 80,000 feet, for example from about 60,000 feet to about 67,000 feet.

A payload 114 and an optional propulsion system can be coupled to the balloon 102, such as by being suspended from the balloon 102. The payload 114 can include instruments, or communication devices, or both, or can include other structures or devices to provide additional functionality to the balloon system 100. In an example, the atmospheric balloon system 100 can be configured to provide observation beneath and around the balloon 102 as well as one or more communication features (e.g., transmission of information, reception of information and the like). The payload 114 can also include an air ballast blower configured to provide atmospheric air to an air ballast chamber 116 and a source of lighter-than-air lift gas configured to provide lighter-than-air lifting gas, such as helium or hydrogen, to a lift gas chamber 118. The payload 114 can also include a controller sized and shaped to control the relative volume of each of one or more balloon chambers, such as the air ballast chamber 116 and the lift gas chamber 118.

In an example, the upper balloon panel 108 and the lower balloon panel 112 cooperate to form an outer membrane 120, also referred to herein as a balloon membrane 120. For example, the upper balloon panel 108 and the lower balloon panel 112 can be coupled along the circumferential edge 110, such as along a seam or edge seal provided by adhering, bonding, melting, or otherwise coupling the upper balloon panel 108 and the lower balloon panel 112 to each other along the circumferential edge 110. As previously described, the balloon 102 can include a lift gas chamber 118 separated from an air ballast chamber 116. The lift gas chamber 118 and the air ballast chamber 116 can be separated by way of a deflectable diaphragm 122 positioned within the dual chamber balloon 102. The deflectable diaphragm 122 can be coupled across the balloon 102, for example by extending inwardly from the circumferential edge 110. The deflectable diaphragm 122 can be interposed between the upper balloon panel 108 and the lower balloon panel 112 at the time of construction of the balloon 102. As the circumferential edge 110 is formed, the deflectable diaphragm 122 can be coupled with each of the upper balloon panel 108 and the lower balloon panel 112 to accordingly form a triple layered dual chamber balloon 102 with the deflectable diaphragm 122 interposed between and coupled with each of the upper balloon panel 108 and the lower balloon panel 112.

With the construction described above, the lift gas chamber 118 is formed by the upper balloon panel 108 and the deflectable diaphragm 122. In other words, the lift gas chamber 118 can be formed by an upper portion of the outer membrane 120 (e.g., the portion of the outer membrane 120 that includes the upper balloon panel 108) as well as the deflectable diaphragm 122. Similarly, the air ballast chamber 116 can be formed by the lower balloon panel 112 and the deflectable diaphragm 122. In other words, the air ballast chamber 116 can be formed by a lower portion of the outer membrane 120 (e.g., the portion of the outer membrane 120 that includes the lower balloon panel 112) and the deflectable diaphragm 122.

The diflectable diaphragm 122 can be coupled across another portion of the balloon 102 other than at the circumferential edge 110. For instance, the outer membrane 120 can have a smaller perimeter than either of the upper or lower balloon panels 108, 112, and can be coupled to either of the panels 108, 122 closer to either of the upper or lower apexes 104, 106, respectively. In still another example, the deflectable diaphragm 122 can be provided as a nested balloon formed of a light weight membrane within the main balloon 102. For instance, the deflectable diaphragm 122 can be a balionet coupled with the balloon 102 at one of the upper or lower apexes 104, 106.

The balloon system 100 can also include a plurality of tendons 124 that can extend from the upper apex 104 to the lower apex 106. The plurality of tendons 124 can be provided in a distributed fashion around the dual chamber balloon 102 and can provide structural integrity to the dual chamber balloon 102 and maintain the dual chamber balloon 102 volume at a constant or substantially level after inflation and during operation of the atmospheric balloon system 100. The tendons 124 can be cables, biodegradable filaments, or the like, fed through a plurality of orifices within the circumferential edge 110 to accordingly maintain the tendons 124 in a distributed fashion around an outer surface 126 of the balloon 102. Alternatively, each tendon 124 can be fed through a corresponding sleeve that is bonded or otherwise coupled to respective portions of the outer membrane 120 in a distributed fashion around the balloon 102.

As an alternative to the design described above with respect to FIG. 1, a balloon can also be formed with a plurality of gore panels or diamond shaped longitudinal panels extending from upper and lower apexes that are joined together to form the balloon. A gore or diamond-shaped panel construction can also include tendons as described above.

Each of the plurality of tendons 124 can be coupled to the upper apex 104 and the lower apex 106. For example, an upper apex plate 128 can be coupled to the balloon 102 at the upper apex 104 and the tendons 124 can be coupled to the upper apex plate 128. The upper apex plate 128 can include a plurality of tendon anchors, wherein an upper end of each of the plurality of tendons 124 can be coupled to a corresponding one of the plurality of upper apex plate tendon anchors. A lower apex plate 130 can be coupled to the balloon 102 at the lower apex 106 and the tendons 124 can be coupled to the lower apex plate 130. The lower apex plate 130 can include a plurality of tendon anchors, similar to the tendon anchors of the upper apex plate 128. A lower end of each of the plurality of tendons 124 can be coupled to a corresponding one of the plurality of lower apex plate tendon anchors.

### Upper Apex Plate

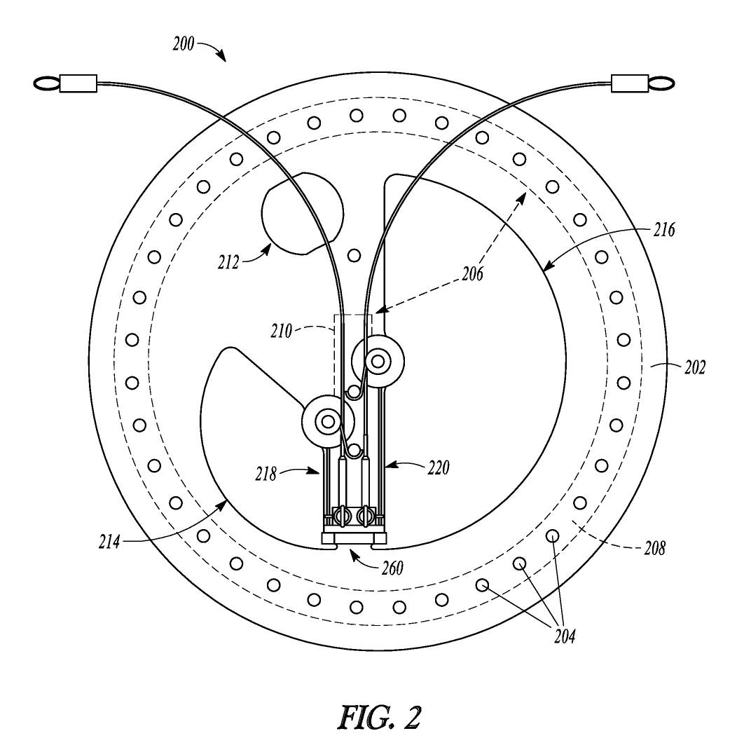

FIG. 2 shows a top view of an example apex plate 200. The example apex plate 200 shown in FIG. 2 and described in further detail below can be used in an atmospheric balloon system, such as in the balloon system 100 described above with respect to FIG. 1. For example, the apex plate 200 shown in FIG. 2 is used as the upper apex plate 128 or the lower apex plate 130 in the balloon system 100 of FIG. 1. For the sake of brevity, in some examples below, the apex plate 200 will be described, generally, in terms of an upper apex plate, such as the upper apex plate 128. However, it will be understood by a person of ordinary skill in the art that the apex plate 200 can be used as a lower apex plate, such as the lower apex plate 130. Indications of direction below when discussing the apex plate 200 that would be understood by the person of ordinary skill in the art as referring to an upper apex plate will readily be understood as potentially being the converse when referring to a lower apex plate, e.g., with terms like “upper” or “above” being understood as being changed to “lower” or “below,” and vice versa.

The example apex plate 200 can include a plate body 202 that forms the main structural support of the apex plate 200. In an example, the plate body 202 can comprise a relatively thick aluminum body, such as a body having a thickness of from about 2 mm (0.08 inches) to about 10 mm (0.4 inches), for example about 5 mm (0.2 inches). The plate body 202 can be, for example, a generally circular shaped plate having a diameter of about 25 cm (10 inches) to about 50 cm (20 inches), such as about 43 cm (17 inches). A plurality of tendon anchors 204 can be anchored to the plate body 202 for coupling to upper ends of a plurality of tendons, such as the tendons 124 described above with respect to FIG. 1. The apex plate 200 can include the plate body 202 having a size and dimensions for securing the plurality of tendons thereto. For example, the apex plate 200 includes tendon anchors 204, with each of the plurality of tendons being coupled to a corresponding tendon anchor 204.

The apex plate 200 can be coupled to a balloon membrane, such as the outer membrane 120 in FIG. 1, with an adhesive 206 rather than previous methods of fastening apex plates to a balloon membrane with bolts or other fasteners. As described in more detail below, the apex plate 200 can be coupled to a balloon membrane with an adhesive 206 that is configured for atmospheric applications, and in particular an adhesive 206 that can withstand the extremely low temperatures that an atmospheric balloon can encounter when flying at high altitudes, e.g., as −80° C., (e.g., about 193° K.) or colder. FIG. 2 shows an example of placement of adhesive 206 on the plate body 202, such as a first bead 208 of the adhesive 206 around a circumference of the circular plate body 202 and a second bead 210 of the adhesive 206, also referred to as a patch 210 of the adhesive 206 at a central location on the plate body 202.

The apex plate 200 can include structures for securing one or more of a fill port and a flight-termination system at the top apex plate. In an example, shown in FIG. 2, the plate body 202 includes a plurality of openings 212, 214, 216 that provide access to the balloon membrane to which the plate body 202 is secured. One opening 212 can be used for installing and securing a fill port assembly for filling a lift gas chamber (e.g., the lift gas chamber 118 in FIG. 1) with a lift gas, such as helium. The opening 212 is, therefore, referred to herein as a fill port opening 212. An example of a fill port asserribly that can be installed in the fill port opening 212 is described in more detail below. Additional openings 214, 216 can be provided in the plate body 202 to expose the balloon membrane. One or more cutting devices can be used within the one or more other openings 214, 216 to cut one or more openings in the balloon membrane to provide for flight termination in the event that it is desired to bring the balloon system back to the ground. These openings 214, 216 are, therefore, referred to herein as termination openings 214, 216.

In an example, one or more cutting devices can reach through the corresponding termination openings 214, 216 to pierce through the balloon membrane and create a membrane opening (e.g., a cut or rupture) through which the lift gas can escape, referred to herein as a flight-termination opening (e.g., a cut or rupture) in the balloon membrane. The flight-termination opening releases lift gas to reduce buoyancy of the balloon and cause it to descend back to the ground. FIG. 2 shows a top view of the example apex plate 200 with one or more cutting devices (in this example two) 218, 220 coupled to the plate body 202 proximate to one or more corresponding termination openings (in this example two) 214, 216. In an example, the termination openings include a first termination opening 214 and a second termination opening 216. In an example, the first termination opening 214 is smaller than the second termination opening 216. A first cutting device 218 that corresponds with the smaller first termination opening 214 produces a relatively smaller balloon flight-termination opening (e.g., cut or rupture) compared to a flight-termination opening produced by a second cutting device 220 that corresponds to the larger termination opening 26. The relatively smaller flight-termination opening formable in examples with the relatively smaller first termination opening 214 provides for a relatively slow release of lift gas and a relatively slower descent. The relative large flight-termination opening formable in examples the relatively larger second termination opening 216 provides for a relatively faster release of lift gas and a relatively faster descent. In an example, the first and second cutting devices 218, 220 can both be operated to produce balloon flight-termination openings through both the smaller first termination opening 214 and through the larger second termination opening 216. Cutting flight-termination openings in both the first termination opening 214 and the second termination opening provides for even faster release of the lift gas compared to either opening individually, and thus provide for a third, relatively faster descent of the balloon. Further details of an example cutting device that can he used for each of the cutting devices 218, 220 is described in more detail below.

### Top Apex Mounted Fill Port

Previously in atmospheric balloons, the fill port for a lift gas has been positioned at a bottom portion of the balloon (e.g., proximate to a bottom apex) or at a side position of the balloon at a horizontal circumferential edge). In some examples, the fill port has been located at a bottom or a side of the balloon in an effort to hold and control the balloon during filling.

Securing a fill port assembly to the top apex plate, e.g., as with the example apex plate 200 shown in FIG. 2, provides for adequate securing and control of the balloon during lifting gas injection. The fill port assembly design described below also provides for superior sealing around the fill port to reduce (e.g., minimize or eliminate) leaking around the fill port. The fill port assembly also provides for more optimized lift gas retention compared to previous fill ports. Further, the fill port assembly provides for better balloon membrane integrity during filling due to a reduction in the balloon membrane being carried and whipped by the lift gas during filling, generally referred to as flagging of the membrane.

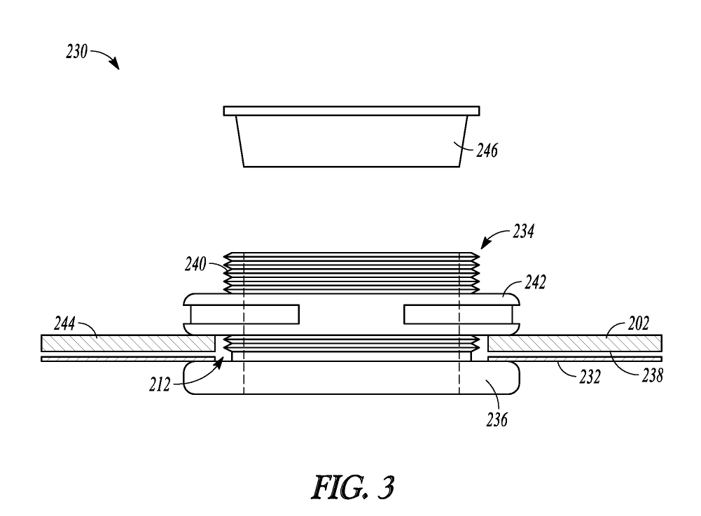

FIG. 3 is a cross-sectional view of an example fill port assembly 230 coupled to the plate body 202 at the fill port opening 212. The fill port assembly 230 includes a bulkhead 234 that is inserted through an opening in the balloon membrane 232 and through the fill port opening 212 in the plate body 202. In an example, the bulkhead 234 includes a flange 236 positionable within an interior of the balloon, e.g., on a bottom side of the balloon membrane 232, and adjacent to a lower surface 238 of the plate body 202. In an example, the bulkhead 234 also includes a hollow post 240 that extends upward from the flange 236. The hollow post 240 is inserted through the opening in the balloon membrane 232 and the fill port opening 212 in the plate body 202. In an example, the fill port assembly 230 includes a locking nut 242 to engage the hollow post 240, causing the locking nut 242 to engage against an upper surface 244 of the plate body 202. In an example, an exterior surface of the hollow post 240 is threaded, which engages with a corresponding threaded interior surface of the locking nut 242. When the threading of the locking nut 242 engages the threading of the hollow post 240, e.g., by tightening down the locking nut 242, the plate body 202 and the balloon membrane 232 are clamped between the locking nut 242 and the bulkhead flange 236. This generates a clamping force between the hollow post 240 and the flange 236 that securely clamps the balloon membrane 232 between the flange 236 and the lower surface 238 of the plate body 202. For this reason, at least a portion of the lower surface 238 will be referred to herein as the lower clamping surface 238. In an example, the clamping force generated between the flange 236 and the lower clamping surface 238 forms a seal between the flange 236 and the balloon membrane 232 and between the balloon membrane 232 and the lower clamping surface 238. In an example, the clamping forms an air-tight or substantially air-tight seal that prevents (e.g., eliminates or reduces) leaking of lift gas around the fill port assembly 230 when the lift gas chamber is filled with lift gas. In this way, the fill port assembly 230, in combination with the balloon membrane 232, provides for better sealing against leaking of the lift gas, such as helium, during flight. In an example, the fill port assembly 230 includes a fill port cap 246 that closes the fill port assembly 230 after filling of the lift gas is complete (e.g., to eliminate or reduce escape of the lift gas from the fill port assembly 230).

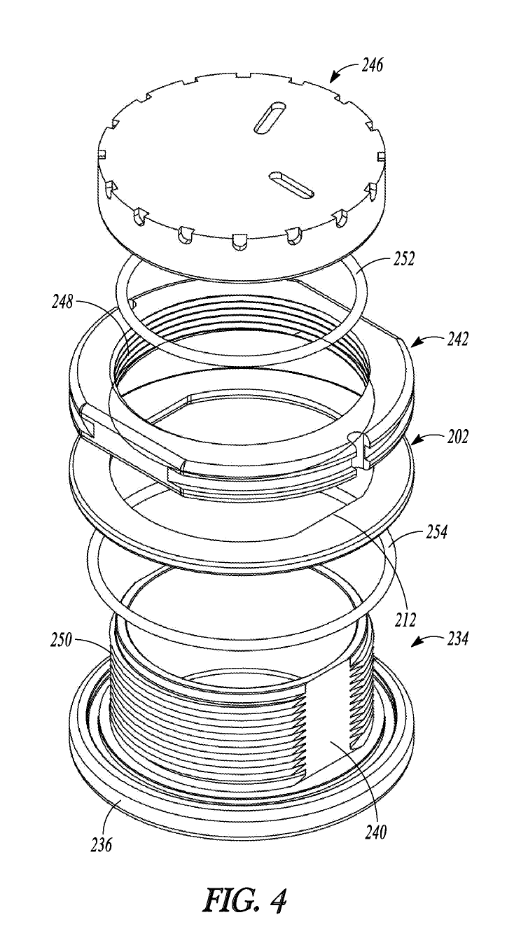

FIG. 4 shows an exploded view of the example fill port assembly 230 described above with respect to FIG. 3. As shown in FIG. 4, in an example, the locking nut 242 includes a threaded surface 248, e.g., an inner threaded surface 248, to engage a corresponding threaded surface 250 of the bulkhead hollow post 240, e.g., an outer threaded surface 250, in order to provide the clamping force between the locking nut 242 and the bulkhead flange 236. In an example, the fill port cap 246 also includes an inner threaded surface, such as an inner threaded surface (not visible in FIG. 4), to engage the threaded surface 250 of the hollow post 240. Other structures can also be used for one or both of engagement and sealing between the locking nut 242 and the hollow post 240 and between the fill port cap 246 and the hollow post 240. In an example, the fill port assembly 230 includes an O-ring 252 between the cap and the hollow post, referred to herein as a cap O-ring 252, to provide a seal to prevent (e.g., eliminate or reduce) leaking of the lift gas between the fill port cap 246 and the hollow post 240. In an example, the fill port assembly 230 includes an O-ring 254 to be positioned between the bulkhead flange 236 and the balloon membrane 232, referred to herein as a flange O-ring 254, to provide a seal to prevent (e.g., eliminate or reduce) leaking of the lift gas through the opening in the balloon membrane 232. The sealing provided by clamping the bulkhead flange 236 and the lower clamping surface 238 of the plate body 202, and, if present, one or more of the O-rings 252, 254, has been found to provide for better sealing and reduced leaking compared to prior fill ports.

As described above, the fill port assembly 230 is secured within the fill port opening 212 of the plate body 202. Securing the fill port assembly 230 within the (rigid and in some cases larger) plate body 202 of the apex plate 200 provides for better securing of the balloon membrane 232 during filling with the lift gas. As noted above, previous fill ports were located on the side or bottom portion of the balloon and were generally only the size necessary for the fill port structure itself. In some cases, this resulted in the balloon membrane being carried and whipped by the lift gas during filling, generally referred to as flagging of the membrane. Flagging tended to occur because the lift gas was typically injected at very high velocities to minimize fill time. Flagging of the membrane was known, on occasion, to lead to weakening of sealing around the fill port and weakening or even breaking of the balloon membrane.

The present inventors have discovered that by co-locating the fill port assembly 230 within the apex plate 200, for instance in the upper apex plate 128, the plate body 202 can provide structural support to the fill port assembly 230 and to the balloon membrane 232. The plate body 202 can also optionally provide structural support to one or more of the seals around the fill port assembly 230, beyond that which was provided by previous fill ports known in the art. The plate body 202, therefore, supports and secures the balloon membrane 232 substantially immediately adjacent to the fill port assembly 230, which minimizes (e.g., eliminates or reduces) movement of the balloon membrane 232, e.g., flagging, in proximity to the fill port assembly 230 during lift gas injection. This support of the balloon membrane 232 and the fill port assembly 230, in turn, results in a more structurally sound balloon membrane 232 that is less likely to be damaged during lift gas injection.

### Flight-Termination System

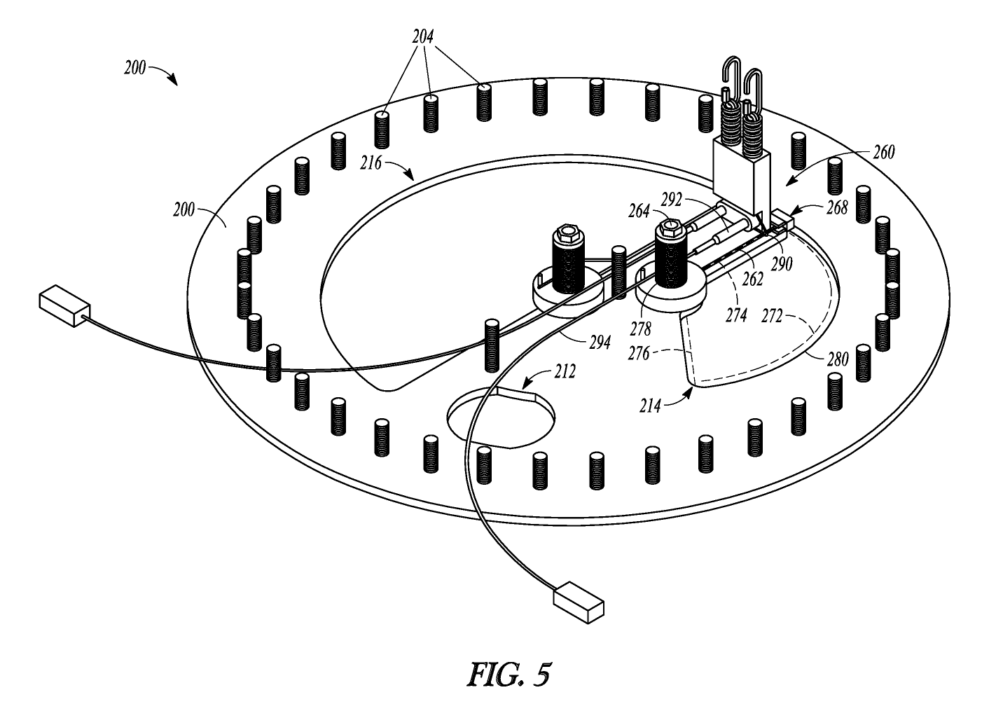

As described above, one or more cutting devices 218, 220 can operate within one or more termination openings 214, 216 in the plate body 202 to cut the balloon membrane 232. In some examples, the one or more termination openings 214, 216 in the plate body 202 and the one or more cutting devices 218, 220 are referred to herein as a flight-termination system 260. FIG. 5 shows a perspective view of the apex plate 200 with selected details of the flight-termination system 260 coupled to the apex plate body 202 such that each cutting device 218, 220 is proximate to its corresponding termination opening 214, 216 in the plate body 202. FIG. 5 show details of the first cutting device 218, e.g., the cutting device 218 coupled proximate to the first termination opening 214.

In an example, the first cutting device 218 includes a support member 262 coupled to the plate body 202. In an example, the support member 262 is an elongate support arm 262. In one example, the support arm 262 is pivotally coupled to the plate body 202, such as with a hinge 264 or other pivotal coupling device, mechanism, or structure. In an example, a proximate end 266 of the support arm 262 is pivotally coupled to the plate body 202, for example by coupling the hinge 264 to the proximate end 266 of the support arm 262. A cutting blade 268 is also coupled to the support arm 262. In an example, the cutting blade 268 is coupled proximate to a distal end 270 of the support arm 262, wherein the distal end 270 is generally opposed to the proximate end 266 pivotally coupled to the plate body 202. In an example, the support arm 262 is configured so that the cutting blade 268 swings through a generally arc-shaped path (referred to as arc 272 for the sake of brevity). The arc 272 of the cutting blade 268, in turn, cuts a flight-termination opening in the balloon membrane 23 that has a curved edge to provide for release of the lift gas and flight termination of the balloon. In an example, the balloon membrane 232 is coupled to the plate body 202, for example with an adhesive 206, so that it spans across the first termination opening 214. In an example, the balloon membrane 232 is held at least partially taut as it spans the first termination opening 214. In an example where the balloon membrane 232 is coupled to the plate body 202 with the adhesive 206, the adhesive 206 holds the flight-termination opening in the balloon membrane 232 open to provide an unobstructed path for the lift gas to escape out of the flight-termination opening.

In an example, the cutting device 218 includes a potential energy source, such as a potential energy structure, that mechanically stores potential energy. The potential energy, when released, drives the support arm from a first position (shown as dashed line 274 in FIG. 5) to a second position (shown as dashed line 276 in FIG. 5). In an example, the potential energy source comprises a spring, such as the exemplary torsion spring 278 shown in FIG. 5. The potential energy source, such as the torsion spring 278, is biased to pivot the support arm 262 from the first position 274 toward the second position 276. The pivoting of the support arm 262 moves so that the cutting blade 268 cuts substantially along a generally arc-shaped edge 280 of the first termination opening 214 (as shown in FIG. 5). As the support arm 262 moves from the first position 274 to the second position 276, the cutting blade 268 pierces through and cuts the balloon membrane 232 along the arc 272 to form the flight-termination opening. By using a mechanically-stored potential energy source, such as the torsion spring 278, the first cutting device 218 is activatable with minimal energy input such that the first cutting device 218 can be activated even if the balloon system has critically low batter power.

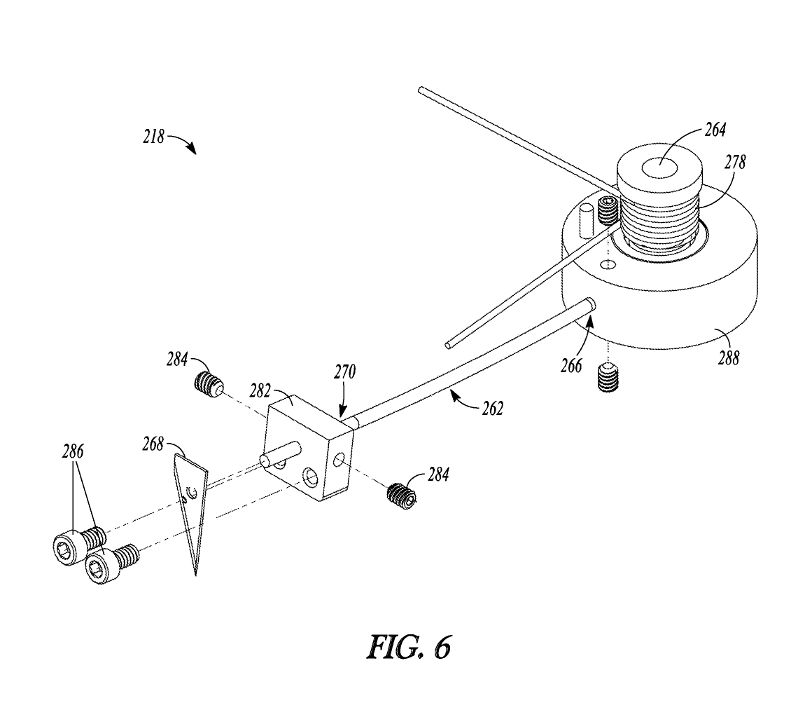

FIG. 6 shows an exploded perspective view of the first cutting device 218. In an example, the first cutting device 218 includes a blade holder 282 coupled to the distal end 270 of the support arm 262 with one or more blade holder fasteners 284, such as one or more screws or other fasteners or adhesive. The cutting blade 268 is coupled to the blade holder 282, such as with one or more cutting blade fasteners 286, such as one or more blade holding bolts or other fasteners or adhesive. In an example, the proximate end 266 of the support arm 262 is coupled to a rotary plate 288. In an example, the rotary plate 288 is rotationally coupled to the plate body 202 so that the rotary plate 288 will rotate relative to the plate body 202, e.g., with a plane of the rotary plate 288 being substantially parallel to a plane of the plate body 202 while the rotary plate 288 rotates relative to the plate body 202. The potential energy source, such as the torsion spring 278 is operationally coupled to the rotary plate 288 such that when the potential energy from the potential energy source is released, it rotates the rotary plate 288 with respect to the plate body 202. The rotation of the rotary plate 288, in turn, pivots the support arm 262 with respect to the plate body 202. In an example, as the rotary plate 288 rotates and the support arm 262 pivots relative to the plate body 202, the cutting blade 268 passes through the arc 272 to cut a generally arc-shaped slit in the balloon membrane 232, which provides for the formation of a flight-termination opening in the balloon membrane 232.

In an example, the first cutting device 218 includes a restraining device that restrains the support arm 262 in the first position 274 when it is not desired to form a flight-termination opening in the balloon membrane 232. The restraining device withstands the potential energy being applied onto the support arm 262 so that the support m 262 remains in the first position 274 and does not move to the second position 276. In an example, the first cutting device 218 further includes a release mechanism configured to disengage the restraining device from the support arm 262, allowing the potential energy source to release its mechanically-stored potential energy and move the support arm 262 from the first position 274 toward the second position 276.

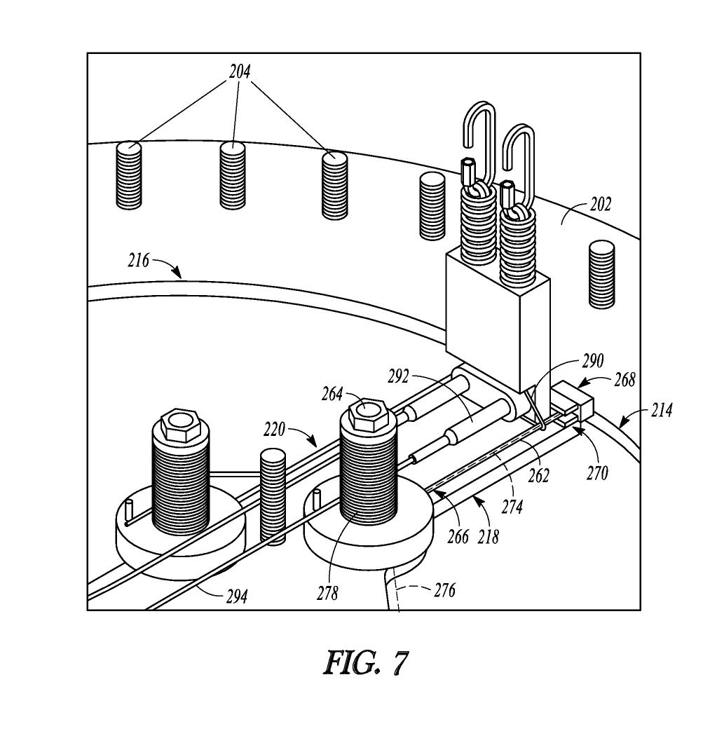

FIG. 7 shows a close-up perspective view of the first cutting device 218 with an example embodiment of a restraining device and an example embodiment of a release mechanism. In the example shown in FIG. 7, the restraining device comprises a restraining cord 290 coupled to the plate body 202 such that the support arm 262 is unable to be moved substantially from the first position 274 to the second position 276 by the potential energy source, such as the torsion spring 278. In other words, the restraining cord 290 is strong enough and is secured in such a way that it can withstand the force being applied by the potential energy source onto the support arm 262 so that the support arm 262 will substantially remain in the first position 274. In an example, the restraining cord 290 comprises a rope, a string, a cable, or another cuttable or otherwise releaseable structure.

In the example of FIG. 7, the release mechanism is a cord cuttin mechanism 292 that cuts through the restraining cord 290, which releases the restraining cord 290 from its restraint of the support arm 262. The release of the restraint on the support arm 262 by the restraining cord 290 allows the potential energy source, e.g., the torsion spring 278, to move the support aim 262 from the first position 274 toward the second position 276. In an example, the cord cutting mechanism 292 is a cord cutting device that has stored energy that can be easily released with little energy input needed. In an example, the cord cutting mechanism 292 is a pyrotechnic cord cutter that uses a pyrotechnic charge to drive a cord cutting structure, such as a blade or other cutter. The driven cord cutting structure then cuts through the restraining cord 290 and releases the support arm 262. A non-limiting example of a pyrotechnic cord cutter that can be used as the cord cutting mechanism 292 is the pyrotechnic cord cutter sold under the trade name CYPRES-1 by Airtec GmbH & Co., Bad Wuennenberg, Germany. The pyrotechnic cord cutter of the cord cutting mechanism 292 can be activated by a signal, such as an electrical signal transmitted to the cord cutting mechanism 292 by a signal cable 294 (FIG. 5), initiated by a controller, for example a controller stored within the payload 114 of the balloon system 100 (FIG. 1). As with the mechanically-stored potential energy of the torsion spring 278 (or other potential energy source), described above, the pyrotechnic energy within a pyrotechnic cord cutter is chemically stored such that a relatively small electrical signal ignites the pyrotechnic charge and cuts the restraining cord 290. The cut restraining cord 290 releases the support arm 262, allowing the mechanically-stored potential energy in the potential energy source, e.g., the torsion spring 278, to drive the support arm 262 from the first position 274 toward the second position 276 no that the cutting blade 268 cuts a flight-termination opening in the balloon membrane 232.

FIGS. 5-7 were described above with respect to the first cutting device 218. However, the second cutting device 220 can have substantially the same configuration as the first cutting device 218, e.g., with a support member such as an elongate support arm, a proximate end pivotally coupled to the plate body 202, a cutting blade at a distal end of the support arm, and a potential energy source to drive the support arm from a first position to a second position so that the cutting blades cuts a path through the balloon membrane 232 to form a second flight-termination opening within the second termination opening 216. The second cutting device 220 can also include a restraining device and a release mechanism, similar or identical to that of the first cutting device 218. Each detail of the second cutting device 220 will not be described as they were for the first cutting device 218. However, a person of ordinary skill in the art will appreciate that the second cutting device 220 can be made with the same or substantially the same components as described above with respect to the first cutting device 218.

### Adhesive Securing of the Apex Plate

As noted above with respect to FIG. 2, in an example, the apex plate 200 is coupled to the balloon membrane 232 with an adhesive 206 that is configured for high-altitude conditions. In some examples, the adhesive 206 used to couple the apex plate 200 to the balloon membrane 232 can withstand extremely low temperatures such as those encountered by a balloon at high altitudes. The use of the adhesive 206 to couple the apex plate 200 to the balloon membrane 232 can reduce the number of potential lift gas leak paths through the balloon membrane 232 compared to previous methods of coupling an apex plate to a membrane. As noted above, previously, apex plates were coupled to atmospheric balloons with fasteners, such as bolts, that passed through fastener-mounting openings or perforations in the balloon membrane to mount the apex plate to the balloon. While bolting or other fastener provides secure connection of an apex plate to the balloon, each fastener required a perforation through the balloon membrane that produces a potential leak path. Each potential leak path typically requires gaskets or other sealing structures to prevent (e.g., eliminate or reduce) leaking of the lift gas through the fastener perforations. The gaskets or other sealing structures increase the system's complexity and weight, and provides another structure that can fail and result in leaking of the balloon.

As used herein, the term “high-altitude conditions,” can refer to an altitude of from about 30,000 feet to about 100,000 feet, such as from about 45,000 feet to about 80,000 feet. “High-altitude conditions” can also refer to a temperature of from about −100° C. to about −30° C., such as from about −90° C. to about −50° C., such as from about −80° C. to about −60° C. In an example, the adhesive 206 used to mount the apex plate 200 to the balloon membrane 232 can comprise a silicone adhesive that can withstand extremely low temperatures at high altitudes. In an example, the adhesive 206, such as a silicone adhesive, can withstand temperatures of −30° C. or colder, −35° C. or colder, −40° C. or colder, −45° C. or colder, −50° C. or colder, −55° C. or colder, −60° C. or colder, −65° C. or colder, −70° C. or colder, −75° C. or colder, or −80° C. or colder. In an example, the adhesive 206 can comprise a silicone-based adhesive 206 made for use in stratospheric exposure, sold under the trade name SSA Tape by Raven Aerostar International, Inc., Sioux Falls, S. Dak., USA.

The use of the adhesive 206 can, in some examples, reduce (e.g., eliminate or decrease) the need to perforate the balloon membrane 232 for the purpose of mounting the apex plate 200 to the balloon membrane 232 (as described above, the balloon membrane 232 may still be perforated for other reasons, such as for the installation of a fill port assembly 230. The use of the adhesive 206 can, in some examples, reduce the complexity and weight of the system by minimizing the need for fasteners to secure the apex plate to the balloon membrane, as well as the need for sealing structures such as gaskets around the securing fasteners.

The present inventors have found, however, that the use of the adhesive 206 for mounting the apex plate 200, such as the upper apex plate 128 or the lower apex plate 130 to an outer membrane 120 is, in some examples, further enhanced as described herein. For example, it has been found that in the case of many silicone-based adhesive materials designed for low-temperature and atmospheric applications, at room temperatures the application of peel stress on the balloon membrane 232 can peel the balloon membrane 232 and the adhesive 206 from the apex plate body 202. As used herein, the term “peel stress” can refer to a stress applied to the balloon membrane 232 and the adhesive 206 that peels the balloon membrane 232 away from the plate body 202, similar to the manner in which a banana peel is peeled away from the fruit. However, the adhesive 206 has also been found to be considerably stronger when a shear stress is applied to the balloon membrane 232 or the plate body 202. The term “shear stress” as used herein, can refer to a stress that is applied generally parallel to the surface of the balloon membrane 232 and the plate body 202 that would tend to cause the balloon membrane 232 to slide along the surface of the plate body 202 or vice versa, e.g., with the balloon membrane 232 remaining in contact with the plate body 202 while the shear stress is applied. The adhesive assembly described below takes advantage of the relatively strong resistance to shear stress of the adhesive 206 by using a structure and configuration that mounts the plate body 202 so that stress is applied to the adhesive as shear stress rather than peel stress.

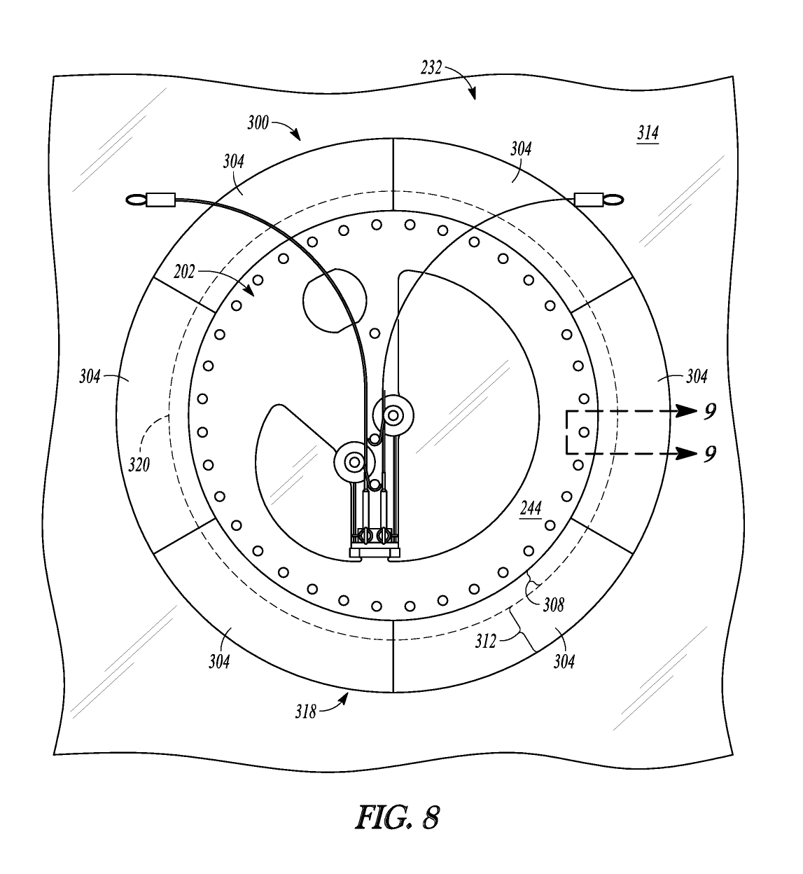

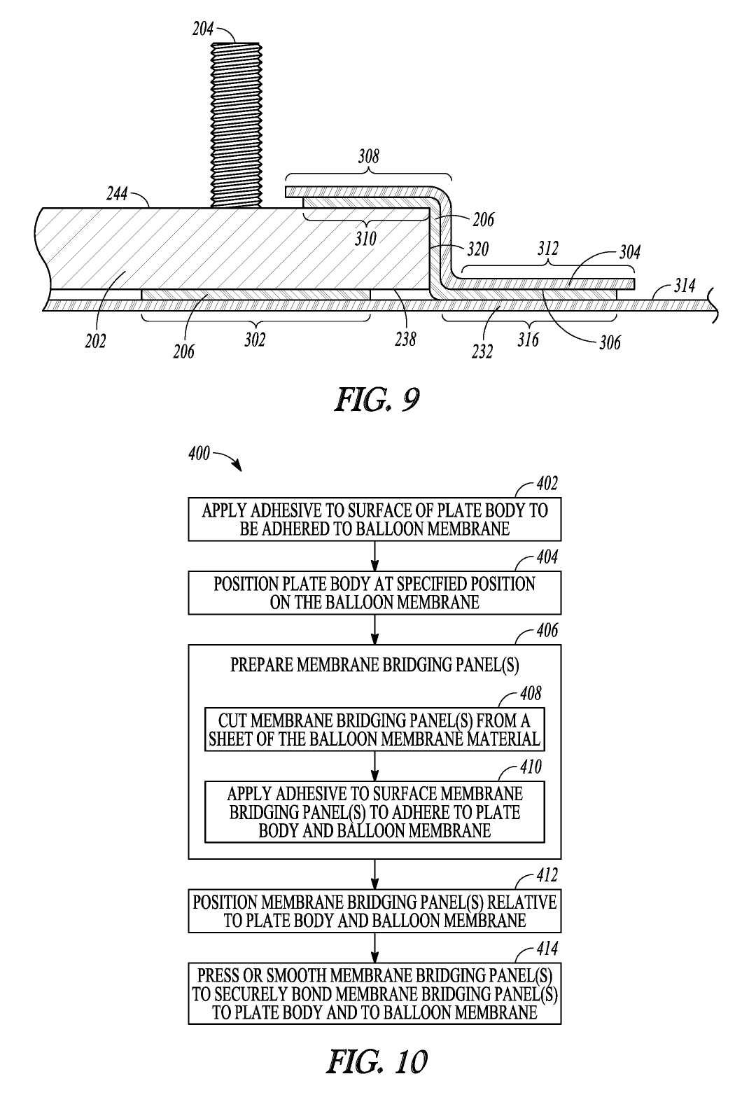

FIGS. 8 and 9 show an example adhesive assembly 300 for coupling the plate body 202 to the balloon membrane 232 with an adhesive 206. FIG. 8 shows a top view of the adhesive assembly 300 with the plate body 202 coupled to the balloon membrane 232, while FIG. 9 shows a cross-sectional side view of the example adhesive assembly 300. The adhesive assembly 300 can include an apex plate adhesive interface 302 between the plate body 202 and the balloon membrane 232 (best seen in FIG. 9). The apex plate adhesive interface 302 anchors the plate body 202 to the balloon membrane 232 using, for example, one or more beads of adhesive 206, such as the first bead 208 around at least a portion of a circumference of the plate body 202 or a second bead 210 of the adhesive 206 generally at the center of the plate body 202 (as shown in FIG. 2), or both.

The adhesive assembly 300 can further include one or more membrane bridging panels 304 made from a polymer film material, which can be the same material as the balloon membrane 232. In an example, the each of the one or more membrane bridging panels 304 can be a generally arc-shaped panel, e.g., a shape that is a section of a generally circular or generally ovular annulus having an inner diameter that is smaller than the outer diameter of the plate body 202 and an outer diameter that is larger than the outer diameter of the plate body 202 (best seen in the top view of FIG. 8). If a plurality of membrane bridging panels 304 is used, then together the plurality of membrane bridging panels 304 generally form a composite bridging structure 318 that is generally ring shaped, e.g., that has the shape of a generally circular or generally ovular annulus, e.g., shaped generally ring with each panel forming a section or portion of the ring of the composite bridging structure 318. In other examples, a continuous or near continuous ring structure can be used as the membrane bridging panel 304.

Each of the membrane bridging panels 304 can include a lower surface 306 to which the adhesive 206 is applied (best seen in FIG. 9). In an example, the adhesive 206 can be applied to substantially the entirety of the lower surface 306 of each of the membrane bridging panels 304. Each of the membrane bridging panels 304 can then be positioned so that a first portion of each membrane bridging panel 304, e.g., an inner portion 308, is coupled to the upper surface 244 of the plate body 202 at a first bridging adhesive interface 310. A second portion of each membrane bridging panel 304, e.g., an outer portion 312, can be coupled to an outer surface 314 of the balloon membrane 232 at a second bridging adhesive interface 316. The one or more membrane bridging panels 304 span between the first bridging adhesive interface 310 and the second bridging adhesive interface 316 to anchor the apex plate 200 to the balloon membrane 232.

The adhesive 206 can be applied at the apex plate adhesive interface 302 (e.g., between a lower surface 238 of the plate body 202 and the outer surface 314 of the balloon membrane 232), at the first bridging adhesive interface 310 (e.g., between the inner portion 308 of each of the one or more membrane bridging panels 304 and the upper surface 244 of the plate body 202), and at the second bridging adhesive interface 316 (e.g., between the outer portion 312 of each of the one or more membrane bridging panels 304 and the outer surface 314 of the balloon membrane 232). In this way, the one or more membrane bridging panels 304 overlap both the upper surface 244 of the plate body 202 and the outer surface 314 of the balloon membrane 232 around a periphery of the apex plate 200. The membrane bridging panels 304 thereby bridge between the upper surface 244 of the plate body 202 and the outer surface 314 of the balloon membrane 232. In another example, each of the one or more membrane bridging panels 304 can also be in close proximity to an outer edge 320 of the plate body 202, e.g., so that the adhesive 206 bonds a portion of each of the membrane bridging panels 304 to the outer edge 320 (best seen in FIG. 9)

The one or more membrane bridging panels 304 can be lapped over the exterior surface of the plate body 202, e.g. the upper surface 244 of the plate body 202 of an upper apex plate 200, and over the outer surface 314 of the balloon membrane 232 while the balloon membrane 232 can be lapped over the interior surface of the plate body 202, e,g., the lower surface 238 of the plate body 202, The lapping of the one or more membrane bridging panels 304 over the plate body 202 and the balloon membrane 232 along with the lapping of the balloon membrane 232 under the plate allows the one or more membrane bridging panels 304 and the balloon membrane 232 to grasp the plate body 202 and to secure it in place relative to the balloon membrane 232. When the balloon system reaches a sufficiently high altitude, e.g., such that the temperature is sufficiently low, the adhesive 206 optionally becomes tackier to better hold the plate body 202 at the apex plate adhesive interface 302. However, even at that point the one or more membrane bridging panels 304 and the first bridging adhesive interface 310 and the second bridging adhesive interface 316 will continue to hold and further secure the plate body 202 in place relative to the balloon membrane 232. When the adhesive structure is assembly and loaded, stress applied to the adhesive 206 will be shear stress rather than peel stress because the one or more bridging panels 304 and their lapped coupling with the balloon membrane 232 and the apex plate 200 will distribute stress along the surfaces of the plate body 202 and the balloon membrane 232, resulting in shear stress, rather than into and out of the balloon, which would result in peel stress. Therefore, the adhesive assembly 300 is robust and provides improved long term survivability with strengthened joints between the plate body 202 and the balloon membrane 232 with minimized leaking.

FIG. 10 shows a flow diagram of an example method 400 for coupling an apex plate body, such as the plate body 202, to a balloon membrane, such as the balloon membrane 232, using an adhesive, such as the adhesive 206, by forming an adhesive assembly, such as the adhesive assembly 300. In the example, the method 400 includes, at step 402, applying adhesive to a surface of the plate body to be adhered to the balloon membrane, such as by applying adhesive 206 to the lower surface 238 of the plate body 202. As described herein, the adhesive on the surface will later form a plate adhesive interface to adhere the plate body to the balloon membrane.

In an example, applying the adhesive to the surface of the plate body 402 includes applying one or more beads of the adhesive to the surface. In an example, applying the adhesive to the surface of the plate body 402 can include applying a bead of adhesive generally as a ring, or several portions of a ring, generally around a circumference of a circular plate body, such as the first bead 208 applied around the circumference of the generally circular plate body 202 shown in dashed lines in FIG. 2. Applying the adhesive to the surface of the plate body 402 can include applying a bead of adhesive at a generally central location of the plate body 202, such as the second bead 210 of the adhesive 206 shown in FIG. 2. Next, at step 404, the plate body can be positioned at a specified position relative to the balloon membrane, for example by positioning the plate body 202 at a desired position on the balloon membrane 232. In an example wherein the plate body is part of an apex plate, then positioning the plate body at the specified position on the balloon membrane 404 can include positioning the plate body at or proximate to a specified apex of the balloon, such as at or proximate to the upper apex 104 of the balloon 102 for an upper apex plate 128 or at or proximate to the lower apex 106 for a lower apex plate 130. Positioning the plate body at the specified position on the balloon membrane 404 can include pressing the plate body onto the balloon membrane so that the adhesive forms a preliminary bond between the plate body and the balloon membrane.

After positioning the plate body at the specified position on the balloon membrane 404, the method 400 can include, at step 406, preparing one or more membrane bridging panels. In example, preparing one or more membrane bridging panels 406 can include cutting each of the one or more membrane bridging panels from a sheet of the material that forms the balloon membrane. In an example, cutting each membrane bridging panel 408 can include cutting a generally arc-shaped panel, e.g., a shape that is a section of a generally circular or generally ovular annulus having an inner diameter that is smaller than the outer diameter of the plate body and an outer diameter that is larger than the outer diameter of the plate body, such as the generally arc-shaped mernbrane bridging panels 304 shown in FIG. 8. If a plurality of generally arc-shaped membrane bridging panels is used, then together the plurality of membrane bridging panels can generally form a composite bridging structure that is generally ring shaped, e.g., that has the shape of a generally circular or generally ovular annulus, e.g., with each membrane bridging panel forming a section or portion of the generally ring-shaped composite bridging structure, such as the generally arc-shaped membrane bridging panels 304 forming the generally ring-shaped composite bridging structure 318 in FIG. 8.

After cutting each membrane bridging panel 408, preparing one or more membrane bridging panels 406 can include, at step 410, applying the adhesive to a surface of each membrane bridging panel that will be adhered to the plate body and the balloon membrane, such as by applying the adhesive 206 to the lower surface 306 of each of the membrane bridging panels 304. As described herein, the adhesive on the surfaces of the one or more membrane bridging panels will later form first and second bridging adhesive interfaces to adhere the one or more membrane bridging panels to the plate body and the balloon membrane, respectively. In an example, applying the adhesive to the surface of each membrane bridging panel 410 can include applying the adhesive substantially to the entirety of the surface to be adhered to the plate body and the membrane opening, such as the lower surface 306 of each of the one or more membrane bridging panels 304.

After preparing one or more membrane bridging panels 406, e.g., after cutting each membrane bridging panel 408 and applying the adhesive to the surface of each membrane bridging panel 410, the method 400 can include, at step 412, positioning each of the one or more membrane bridging panels relative to the plate body and the balloon membrane, e.g., so that a first portion of each of the one or more membrane bridging panels is at a specified position relative to the plate body and a second portion of each of the one or more membrane bridging panels is at a specified position relative to the balloon membrane around a periphery of the plate body. In an example wherein the membrane bridging panels 304 are generally arc-shaped, positioning each membrane bridging panel 412 can include positioning a radially inner portion of each membrane bridging panel over a radially outer portion of the plate body and positioning a radially outer portion of each membrane bridging panel over the balloon membrane around a periphery of the plate body, such as the inner portion 308 of the membrane bridging panels 304 positioned over an outer edge of the plate body 202 and the outer portion 312 of the membrane bridging panels 304 positioned over the balloon membrane 232 around the periphery of the plate body 202 as shown in FIGS. 9 and 10. Positioning each membrane bridging panel 412 can include positioning each of the one or more membrane bridging panels so that it overlaps a portion of the surface of the plate body that is opposite the surface adhered to the balloon membrane, such as the upper surface 244 of the plate body 202 opposite the lower surface 238 adhered to the balloon membrane 232 (best seen in FIG. 9), and so that the membrane bridging panel also overlaps a portion of the outer surface of the balloon membrane around the periphery of the plate body, such as the outer surface 314 of the balloon membrane 232 around the periphery of the plate body 202.

After positioning each membrane bridging panel 412, the method 400 can include, at step 414, pressing or smoothing each of the one or more membrane bridging panels so that each membrane bridging panel is securely bonded to the surface of the plate body and to the outer surface of the balloon membrane. In an example with generally arc-shaped membrane bridging panels 304, pressing or smoothing the one or more membrane bridging panels 414 can include pressing and/or smoothing the inner portion 308 of each of the membrane bridging panels 304 onto the upper surface 244 of the plate body 202 and by pressing and/or smoothing the outer portion 312 of each of the membrane bridging panels 304 onto the outer surface 314 of the balloon membrane 232 around the periphery of the plate body 202. In an example, pressing or smoothing the one or more membrane bridging panels 414 can be performed from the plate body radially outward onto the balloon membrane, e.g., from the inner portion 308 toward the outer portion 312 of the membrane bridging panel 304. In an example, pressing or smoothing the one or more membrane bridging panels 414 can be performed from the balloon membrane radially inward onto the plate body, e.g., from the outer portion 312 toward the inner portion 308 of the membrane bridging panel 304. In an example, pressing or smoothing the one or more membrane bridging panels 414 provides for grasping of the plate body between the one or more membrane bridging panels and the balloon membrane, for example by grasping the plate body 202 between the membrane bridging panels 304 and the balloon membrane 232 (best seen in FIG. 9). In an example, pressing or smoothing the one or more membrane bridging panels 414 can include pressing the one or more membrane bridging panels onto an outer edge of the plate body so that at least a portion of the one or more membrane bridging panels is bonded to the outer edge, such as by pressing a portion of each of the membrane bridging panels 304 (e.g., a portion between the inner portion 308 and the outer portion 312) onto the outer edge 320 of the plate body 202. Pressing and bonding the membrane bridging panel to an edge of the plate body can provide for further grasping and securing of the plate body onto the balloon membrane.

In an example, pressing or smoothing the one or more membrane bridging panels 414 can comprise pressing or smoothing the one or more membrane bridging panels to closely follow a profile of the plate body and the balloon membrane, which will also provide for bonding of the one or more membrane bridging panels to the balloon membrane in very close proximity to the outer edge of the plate body. By pressing and bonding the membrane bridging panels so that they closely follow this profile and so that the one or more membrane bridging panels are bonded to the balloon membrane proximate to the outer edge of the plate body, the one or more membrane bridging panels can work together to limit peel stress applied between the plate body and the balloon membrane and instead distribute the stress either as shear stress between the balloon membrane and the plate body or as shear stress between the one or more membrane bridging panels and the plate body. As noted above, the adhesive provides relatively strong resistance to shear stress, and thus pressing the one or more membrane bridging panels so that they closely file the profile of the plate body, such as by pressing the one or more membrane bridging panels 304 onto the outer edge 320 of the plate body 202 (best seen in FIG. 9), provides for a tight grasp and secure holding of the plate body to the balloon membrane using adhesive, the one or more membrane bridging panels, and the balloon membrane without requiring other fasteners that are driven through the balloon membrane. This can provide for reduced potential leak paths for the lift gas, a simplified design for coupling the apex plate to the balloon membrane, and a lighter load on the balloon because the adhesive and the one or more membrane bridging panels can be substantially lighter than bolts or other fasteners used to mount an apex plate to a balloon membrane.

Further details regarding balloons for which the apex assembly of the present disclosure can be used are described in: U.S. Provisional Patent Application Ser. No. 61/734,820, titled “High Altitude Balloon,” filed on Dec. 7, 2012; U.S. patent application Ser. No. 13/827,779, titled “High Altitude Balloon System,” filed on Mar. 14, 2013; and PCT Application No. PCT/US2013/073630, filed Dec. 6, 2013, published as WO 2014/089465 on Jun. 12, 2014, titled “High Altitude Balloon System,” the disclosures of which are incorporated herein by reference as if reproduced in their entirety.

In order to provide further detail regarding the aspects of an atmospheric balloon system described herein, the following non-limiting list of Embodiments is provided for illustrative purposes.

EMBODIMENT 1 includes an atmospheric balloon system including an upper apex mounted fill port, the system comprising:
a balloon comprising an outer membrane extending between an upper apex and a lower apex, the outer membrane surrounding a balloon chamber; and
an apex plate coupled to the outer membrane at or near the upper apex, the apex plate comprising:
   a plate body coupled to the outer membrane, and
   a fill port assembly coupled to the plate body and in communication with the balloon chamber for inflation of the balloon.

EMBODIMENT 2 includes the atmospheric balloon system of EMBODIMENT 1, wherein the outer membrane includes a membrane opening at or near the upper apex and the plate body includes a fill port plate opening aligned at least partially with the membrane opening, wherein the plate body comprises an upper surface and a lower clamping surface, and wherein the fill port assembly comprises:
a bulkhead comprising a flange and a hollow post extending from the flange, wherein the hollow post is inserted through the membrane opening and the fill port plate opening and the outer membrane is clamped between the flange and the lower clamping surface; and
a locking nut engaged with the hollow post, wherein the locking nut engages with the upper surface of the plate body to lock the clamped membrane between the flange and the lower clamping surface.

EMBODIMENT 3 includes the atmospheric balloon system EMBODIMENT 2, wherein the clamping of the flange and the lower clamping surface seals the outer membrane to the apex plate.

EMBODIMENT 4 includes the atmospheric balloon system of EMBODIMENT 3, wherein the clamping of the flange and the lower clamping surface forms an air-tight seal between the outer membrane and the apex plate.

EMBODIMENT 5 includes the atmospheric balloon system of either one of EMBODIMENTS 3 or 4, wherein the fill port assembly further comprises an O-ring coupled along the flange, and the O-ring is clamped against the outer membrane to seal the outer membrane to the apex plate as the outer membrane is clamped between the flange and the lower clamping surface.

EMBODIMENT 6 includes the atmospheric balloon system of any one of EMBODIMENTS 2-5, wherein the fill port assembly further comprises a fill port cap engageable with one or more of the hollow post or the locking nut.

EMBODIMENT 7 includes an atmospheric balloon system including a membrane cutting device, the system comprising:
a balloon comprising an outer membrane extending between an upper apex and a lower apex; and
an apex plate coupled to the outer membrane, the apex plate comprising:
   a plate body including a first termination opening, wherein a portion of the outer membrane of the balloon is spread across the first termination opening, wherein the plate body retains the outer membrane spread across the first termination opening along at least a portion of a first termination opening periphery; and
   a first membrane cutting device coupled to the plate body, wherein the first membrane cutting device cuts through the outer membrane spread across the first termination opening to form a first balloon flight-termination opening.

EMBODIMENT 8 includes the atmospheric balloon system of EMBODIMENT 7, wherein the first termination opening comprises an edge along at least a portion of the first termination opening periphery, wherein the first membrane cutting device cuts along the edge of the first termination opening.

EMBODIMENT 9 includes the atmospheric balloon system of EMBODIMENT 8, wherein the edge has at least a portion that is arc shaped.

EMBODIMENT 10 includes the atmospheric balloon system of either one of EMBODIMENTS 8, wherein the edge has at least a portion that is a circular arc or an elliptical arc.

EMBODIMENT 11 includes the atmospheric balloon system of any one of EMBODIMENTS 7-10, wherein the first membrane cutting device comprises:
a support member coupled to the plate body;
a potential energy source to move the support member from a first position to a second position;
a restraining device to restrain the support member in the first position;
a release mechanism to disengage the restraining device from the support member to allow the potential energy source to move the support member from the first position to the second position; and
a cutting blade coupled to the support member, wherein the cutting blade cuts through the outer membrane to form the first balloon flight-termination opening as the support member moves from the first position to the second position.

EMBODIMENT 12 includes the atmospheric balloon system of EMBODIMENT 11, wherein the potential energy source comprises a spring.

EMBODIMENT 13 includes the atmospheric balloon system of either one of EMBODIMENTS 11 or 12, wherein the support member is pivotally coupled to the plate body so that the support member pivots in an arc shape when moving from the first position to the second position.

EMBODIMENT 14 includes the atmospheric balloon system of EMBODIMENT 13, wherein the potential energy source comprises a torsion spring.

EMBODIMENT 15 includes the atmospheric balloon system of any one of EMBODIMENTS 11-14, wherein the restraining device comprises a cord to secure the support member in the first position, and wherein the release mechanism comprises a cord cutting mechanism to cut the cord and releases the support member so that the potential energy source will move the support member from h first position to the second position.

EMBODIMENT 16 includes the atmospheric balloon system of EMBODIMENT 15, wherein the cord cutting mechanism comprises a pyrotechnic cutter.

EMBODIMENT 17 includes the atmospheric balloon system of EMBODIMENT 16, wherein the pyrotechnic cutter cuts through the cord in response to a trigger signal from a controller.

EMBODIMENT 18 includes the atmospheric balloon system of any one of EMBODIMENTS 7-17, wherein the plate body further includes a second termination opening, wherein the plate body retains the outer membrane spread across the second termination opening along at least a portion of a second termination opening periphery, further comprising a second membrane cutting device coupled to the plate body, wherein the second membrane cutting device cuts through the outer membrane spread across the second termination opening to form a second balloon flight-termination opening.

EMBODIMENT 19 includes the atmospheric balloon system of EMBODIMENT 18, wherein the second balloon flight-termination opening has a size that is different than that of the first balloon flight-termination opening.

EMBODIMENT 20 includes the atmospheric balloon system of EMBODIMENT 19, wherein the second membrane cutting device comprises:
a support member coupled to the plate body;
a potential energy source to move the support member from a first position to a second position;
a restraining device to restrain the support member in the first position;
a release mechanism to disengage the restraining device from the support member to allow the potential energy source to move the support member from the first position to the second position; and
a cutting blade coupled to the support member, the cutting blade positioned to cut through the outer membrane to form the second balloon flight-termination opening as the support member moves from the first position to the second position.

EMBODIMENT 21 includes an atmospheric balloon system with an adhesive-mounted apex plate, the system comprising:
a balloon comprising an outer membrane extending between an upper apex and a lower apex;
an apex plate coupled to the outer membrane at or near the upper apex; and
an adhesive assembly comprising:
   a plate adhesive interface between the apex plate and the outer membrane, wherein the plate adhesive interface anchors the apex plate to the outer membrane;
   one or more bridging panels, wherein a first portion of the one or more bridging panels is coupled to the apex plate at a first bridging adhesive interface and a second portion of the one or more bridging panels is coupled to the outer membrane at a second bridging adhesive interface, wherein the one or more bridging panels span between the first bridging adhesive interface and the second bridging adhesive interface and anchor the apex plate to the outer membrane, and an adhesive at the plate adhesive interface and at the first and second coupling interfaces, wherein the adhesive maintains coupling between each of the apex plate, the one or more bridging panels, and the outer membrane under high-altitude conditions.

EMBODIMENT 22 includes the atmospheric balloon system of EMBODIMENT 21, wherein the one or more bridging panels are lapped over an exterior surface of the outer membrane and an exterior portion of the apex plate, and the outer membrane is lapped over an interior portion of the apex plate.

EMBODIMENT 23 includes the atmospheric balloon system of either one of EMBODIMENTS 21 or 22, wherein the one or more bridging panels and the outer membrane grasp the apex plate along the exterior and interior portions.

EMBODIMENT 24 includes the atmospheric balloon system of any one of EMBODIMENTS 21-23, wherein the adhesive maintains the coupling of the apex plate to the outer membrane at a temperature of −80° C.

EMBODIMENT 25 includes the atmospheric balloon system of any one of EMBODIMENTS 21-24, wherein the adhesive comprises a silicone adhesive.

EMBODIMENT 26 includes the atmospheric balloon system of any one of EMBODIMENTS 21-25, wherein the one or more bridging panels comprise a plurality of membrane bridging panels each comprising an upper surface and a lower surface, wherein a first portion of the lower surface of each of the plurality of membrane bridging panels is abutted against an apex plate upper surface and a second portion of the lower surface of each of the plurality of membrane bridging panels is abutted against an upper surface of the outer membrane proximate to the apex plate, wherein the adhesive is applied between the first portions of the lower surfaces of the plurality of membrane bridging panels and the apex plate upper surface and the second portions of the lower surfaces of the plurality of membrane bridging panels and the upper surface of the outer membrane to secure the apex plate to the outer membrane.

EMBODIMENT 27 includes the atmospheric balloon system of EMBODIMENT 26, wherein each of the plurality of membrane bridging panels comprises an arc shape, wherein the plurality of membrane bridging panels forms a composite bridging structure shaped generally as a ring around an apex plate periphery.

EMBODIMENT 28 includes the atmospheric balloon system of any one of EMBODIMENTS 21-27, further comprising a plurality of tendons extending over the outer membrane from the upper apex to the lower apex, each of the plurality of tendons being anchored to the apex plate.

EMBODIMENT 29 includes a method of securing an apex plate to an atmospheric balloon using an adhesive, the method comprising:

adhering an apex plate lower surface to an upper surface of a balloon membrane at or near an upper apex of the balloon membrane using an adhesive;

applying the adhesive to a lower surface of each of one or more membrane bridging panels;
adhering a first portion of the one or more membrane bridging panels to an apex plate upper surface and adhering a second portion of the one or more membrane bridging panels to the upper surface of the balloon membrane proximate to the apex plate; and
bridging the one or more membrane bridging panels between the apex plate and the balloon membrane such that the one or more membrane bridging panels secure the apex plate in position on the balloon membrane.

EMBODIMENT 30 includes the method of EMBODIMENT 29, wherein the one or more membrane bridging panels comprise a plurality of membrane bridging panels, wherein a first portion of each lower surface of each of the plurality of membrane bridging panels is abutted against the apex plate upper surface and a second portion of each lower surface of each of the plurality of membrane bridging panels is abutted against the upper surface of the balloon membrane such that the plurality of membrane bridging panels secure the apex plate in position on the upper surface of the balloon membrane.

EMBODIMENT 31 includes the method of EMBODIMENT 30, wherein each of the plurality of membrane bridging paneis comprises an arc shape, wherein the plurality of membrane bridging panels forms a composite bridging structure shaped generally as a ring around an apex plate periphery.

EMBODIMENT 32 includes the method of either one of EMBODIMENTS 30 or 31, wherein the adhesive maintains the coupling of the apex plate to the balloon membrane at a temperature of −80° C.

EMBODIMENT 33 includes the method of EMBODIMENT 32, wherein the adhesive comprises a silicone adhesive.

EMBODIMENT 34. An atmospheric balloon system including an upper apex plate, the system comprising:
a balloon comprising an outer membrane extending between an upper apex and a lower apex, the outer membrane surrounding a balloon chamber;
an apex plate coupled to the outer membrane at or near the upper apex, the apex plate comprising:
   a plate body coupled to the outer membrane, the plate body including a first termination opening, wherein a portion of the outer membrane is spread across the first termination opening, wherein the plate body retains the outer membrane spread across the first termination opening along at least a portion of a first termination opening periphery; and
   a first membrane cutting device coupled to the plate body, wherein the first membrane cutting device cuts through the outer membrane spread across the first termination opening to form a first balloon flight-termination opening; a fill port assembly coupled to the plate body and in communication with the balloon chamber for inflation of the balloon;
an adhesive assembly comprising:
   one or more bridging panels, wherein a first portion of the one or more bridging panels is coupled to the apex plate at a first coupling interface and a second portion of the one or more bridging panels is coupled to the outer membrane at a second coupling interface such that the one or more bridging panels span between the first coupling interface and the second coupling interface, and
   adhesive between the outer membrane and the apex plate, between the one or more bridging panels and the apex plate at the first coupling interface, and between the one or more bridging panels and the outer membrane at the second coupling interface, wherein the adhesive maintains coupling between the apex plate and the outer membrane under high-altitude conditions; and
a plurality of tendons extending over the outer surface from the upper apex to the lower apex, each of the plurality of tendons being anchored to the apex plate.

EMBODIMENT 35 includes the atmospheric balloon system of EMBODIMENT 34, wherein the outer membrane includes a membrane opening at or near the upper apex and the plate body includes a fill port plate opening aligned at least partially with the membrane opening, wherein the plate body comprises an upper surface and a lower clamping surface, and wherein the fill port assembly comprises:
a bulkhead comprising a flange and a hollow post extending from the flange, wherein the hollow post is inserted through the membrane opening and the fill port plate opening and the outer membrane is clamped between the flange and the lower clamping surface; and
a locking nut engaged with the hollow post, wherein the locking nut engages with the upper surface of the plate body to lock the clamped outer membrane between the flange and the lower clamping surface.

EMBODIMENT 36 includes the atmospheric balloon system of EMBODIMENT 35, wherein the clamping of the flange and the lower clamping surface seals the outer membrane to the apex plate.

EMBODIMENT 37 includes the atmospheric balloon system of any one of EMBODIMENTS 34-36, wherein the first membrane cutting device comprises:
a support member coupled to the plate body;
a potential energy source to move the support member from a first position to a second position;
a restraining device to restrain the support member in the first position;
a release mechanism to disengage the restraining device from the support member to allow the potential energy source to move the support member from the first position to the second position; and
a cutting blade coupled to the support member, the cutting blade cuts through the outer membrane to form the first balloon flight-termination opening as the support member moves from the first position to the second position.

EMBODIMENT 38 includes the atmospheric balloon system of EMBODIMENT 37, wherein:
the support member is pivotally coupled to the plate body so that the support member pivots in an arc shape when moving from the first position to the second position;
the potential energy source comprises a torsion spring;
the restraining device comprises a cord to secure the support member in the first position, and wherein the release mechanism comprises a cord cutting mechanism to cut the cord and releases the support member so that the potential energy source will move the support member from the first position to the second position; and
the cord cutting mechanism comprises a pyrotechnic cutter that cuts through the cord in response to a trigger signal from a controller.

EMBODIMENT 39 includes the atmospheric balloon system of any one of EMBODIMENTS 34-38, wherein the plate body further includes a second termination opening, wherein the plate body retains the outer membrane spread across the second termination opening along at least a portion of a second termination opening periphery, further comprising a second membrane cutting device coupled to the plate body, wherein the second membrane cutting device cuts through the outer membrane spread across the second termination opening to form a second balloon flight-termination opening.

EMBODIMENT 40 includes the atmospheric balloon system of EMBODIMENT 39, wherein the second balloon flight-termination opening has a size that is different than that of the first balloon flight-termination opening.

EMBODIMENT 41 includes the atmospheric balloon system of any one of EMBODIMENTS 34-40, wherein the one or more bridging panels comprise a plurality of membrane bridging panels each comprising an upper surface and a lower surface, wherein a first portion of the lower surface of each of the plurality of membrane bridging panels is abutted against an apex plate upper surface and a second porticm of the lower surface of each of the plurality of membrane bridging panels is abutted against an upper surface of the outer membrane proximate to the apex plate; wherein the adhesive is applied between the first portions of the lower surfaces of the plurality of membrane bridging panels and the apex plate upper surface and the second portions of the lower surfaces of the plurality of membrane bridging panels and the upper surface of the outer membrane to secure the apex plate to the outer membrane.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can he tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

What is claimed is:

1. An atmospheric balloon system including an upper apex mounted fill port, the system comprising:
a balloon comprising an outer membrane extending between an upper apex and a lower apex, the outer membrane surrounding a balloon chamber; and
an apex plate coupled to the outer membrane at or near the upper apex, the apex plate comprising:
a plate body coupled to the outer membrane, and
a fill port assembly coupled to the plate body and in communication with the balloon chamber for inflation of the balloon.

2. The atmospheric balloon system of claim 1, wherein the outer membrane includes a membrane opening at or near the upper apex and the plate body includes a fill port plate opening aligned at least partially with the membrane opening, wherein the plate body comprises an upper surface and a lower clamping surface, and wherein the fill port assembly comprises:
a bulkhead comprising a flange and a hollow post extending from the flange, wherein the hollow post is inserted through the membrane opening and the fill port plate opening and the outer membrane is clamped between the flange and the lower clamping surface; and
a locking nut engaged with the hollow post, wherein the locking nut engages with the upper surface of the plate body to lock the clamped membrane between the flange and the lower clamping surface.

3. The atmospheric balloon system of claim 2, wherein the clamping of the flange and the lower clamping surface seals the outer membrane to the apex plate.

4. The atmospheric balloon system of claim 3, wherein the fill port assembly further comprises an O-ring coupled along the flange, and the O-ring is clamped against the outer membrane to seal the outer membrane to the apex plate as the outer membrane is clamped between the flange and the lower clamping surface.

5. An atmospheric balloon system including a membrane cutting device, the system comprising:
a balloon comprising an outer membrane extending between an upper apex and a lower apex; and
an apex plate coupled to the outer membrane proximate to the upper apex, the apex plate comprising:
a plate body including a first termination opening, wherein a portion of the outer membrane of the balloon is spread across the first termination opening, wherein the plate body retains the outer membrane spread across the first termination opening along at least a portion of a first termination opening periphery; and
a first membrane cutting device coupled to the plate body, wherein the first membrane cutting device cuts through the outer membrane spread across the first termination opening to form a first balloon flight-termination opening.

6. The atmospheric balloon system of claim 5, wherein the first termination opening comprises an edge along at least a portion of the first termination opening periphery, wherein the first membrane cutting device cuts along the edge of the first termination opening.

7. The atmospheric balloon system of claim 6, wherein the edge has at east a portion that is arc shaped.

8. The atmospheric balloon system of claim 5, wherein the first membrane cutting device comprises:
a support member coupled to the plate body;
a potential energy source to move the support member from a first position to a second position;
a restraining device to restrain the support member in the first position;
a release mechanism to disengage the restraining device from the support member to allow the potential energy source to move the support member from the first position to the second position; and
a cutting blade coupled to the support member, wherein the cutting blade cuts through the outer membrane to form the first balloon flight-termination opening as the support member moves from the first position to the second position.

9. The atmospheric balloon system of claim 8, wherein the potential energy source comprises a spring.

10. The atmospheric balloon system of claim 8, wherein the support member is pivotally coupled to the plate body so that the support member pivots in an arc shape when moving from the first position to the second position.

11. The atmospheric balloon system of claim 8, wherein the restraining device comprises a cord to secure the support member in the first position, and wherein the release mechanism comprises a cord cutting mechanism to cut the cord and releases the support member so that the potential energy source will move the support member from the first position to the second position.

12. The atmospheric balloon system of claim 11, wherein the cord cutting mechanism comprises a pyrotechnic cutter.

13. The atmospheric balloon system of claim 5, wherein the plate body further includes a second termination opening, wherein the plate body retains the outer membrane spread across the second termination opening along at least a portion of a second termination opening periphery, further comprising a second membrane cutting device coupled to the plate body, wherein the second membrane cutting device cuts through the outer membrane spread across the second termination opening to form a second balloon flight-termination opening.

14. The atmospheric balloon system of claim 13, wherein the second balloon flight-termination opening has a size that is different than that of the first balloon flight-termination opening.

15. An atmospheric balloon system including an adhesive-mounted apex plate, the system comprising:
a balloon comprising an outer met brane extending between an upper apex and a lower apex;
an apex plate coupled to the outer membrane at or near the upper apex; and
an adhesive assembly comprising:
a plate adhesive interface between the apex plate and the outer membrane, wherein the plate adhesive interface anchors the apex plate to the outer membrane;
one or more bridging panels, wherein a first portion of the one or more bridging panels is coupled to the apex plate at a first bridging adhesive interface and a second portion of the one or more bridging panels is coupled to the outer membrane at a second bridging adhesive interface, wherein the one or more bridging panels span between the first bridging adhesive interface and the second bridging adhesive interface and anchor the apex plate to the outer membrane, and an adhesive at the plate adhesive interface and at the first and second bridging adhesive interfaces, wherein the adhesive maintains coupling between each of the apex plate, the one or more bridging panels, and the outer membrane under high-altitude conditions.

16. The atmospheric balloon system of claim 15, wherein the one or more bridging panels are lapped over an exterior surface of the outer membrane and an exterior portion of the apex plate, and the outer membrane is lapped over an interior portion of the apex plate, wherein the one or more bridging panels and the outer membrane grasp the apex plate along the exterior and interior portions.

17. The atmospheric balloon system of claim 15, wherein the adhesive maintains the coupling of the apex plate to the outer membrane at a temperature of −80° C.

18. The atmospheric balloon system of claim 15, wherein the adhesive comprises a silicone adhesive.

19. The atmospheric balloon system of claim 15 wherein the one or more bridging panels comprise a plurality of membrane bridging panels each comprising an upper surface and a lower surface, wherein a first portion of the lower surface of each of the plurality of membrane bridging panels is abutted against an apex plate upper surface and a second portion of the lower surface of each of the plurality of membrane bridging panels is abutted against an upper surface of the outer membrane proximate to the apex plate, wherein the adhesive is applied between the first portions of the lower surfaces of the plurality of membrane bridging panels and the apex plate upper surface and the second portions of the lower surfaces of the plurality of membrane bridging panels and the upper surface of the outer membrane to secure the apex plate to the outer membrane.

20. The atmospheric balloon system of claim 19, wherein each of the plurality of membrane bridging panels comprises an arc shape, wherein the plurality of membrane bridging panels forms a composite bridging structure around an apex plate periphery.
